(19) United States
(12) Patent Application Publication
(10) Pub. No.: US 2009/0152093 A1
(43) Pub. Date: Jun. 18, 2009

(54) LIQUID TREATMENT DEVICE AND METHOD

(76) Inventor: Frederick William Millar, Victoria (AU)

Correspondence Address: REED SMITH LLP, P.O. BOX 488, PITTSBURGH, PA, 15230-0488, US

(21) Appl. No.: 11/719,670

(22) PCT Filed: Nov. 29, 2005
(86) PCT No.: PCT/AU2005/001796

§ 371 Date: May 18, 2007

(30) Foreign Application Priority Data
Nov. 29, 2004 (AU) 2004906791
Oct. 27, 2005 (AU) 2005905948

(51) Int. Cl. C02F 1/04; C02F 103/08; B01D 3/02

(52) U.S. Cl. 203/10; 202/185.1; 202/185.5

(57) ABSTRACT

A distillation device for treating liquid to be purified comprising: a) a boiler having an upper chamber (1B) and a lower chamber (1A); b) a liquid delivery system (1) for delivering the liquid to the lower chamber (1A); c) a heater (14) to heat the lower chamber (1A) to a predetermined temperature at which the liquid will be vaporized upon entering and/or contacting a surface of the lower chamber (1A); d) a vapor collector (9, 11) located in the upper chamber (1B) to receive and collect the vapor emanating from the lower chamber (1A); and e) a condenser (1C) in communication with the vapor collector (9, 11) to receive and condense that vapor into purified liquid.

### FIELD OF THE INVENTION

This invention relates to a liquid treatment device and methods that can be utilised wherever distillation is required. The technology can also be used to reduce energy consumption for hot water based appliances such as hot water service tanks and other like applications.

It is also the intention of the invention to provide an efficient and innovative means of purifying polluted or sea water, or the like, by means of a unique faster method of distillation than the current conventional methods. The application of this different technology, when used for desalination purposes, also produces sodium chloride as a useable by-product. As a consequence, the invention is environmentally friendly as there is no toxic brine to be disposed of.

It also provides for a means to progressively remove the sodium chloride from the boiling chamber of the distiller into, and remove it from, a storage hopper.

The invention also includes the provision of means for automated self-cleaning of the distillation device.

The technology can also be modified and adapted for use with appliances using water such as hot water service tanks to reduce power consumption and manufacturing costs.

### BACKGROUND TO THE INVENTION

In this specification where a document, act or item of knowledge is referred to or discussed, this reference or discussion is not an admission that the document, act or item of knowledge or any combination thereof was at the priority date publicly available, known to the public, part of the common general knowledge or known to be relevant to an attempt to solve any problem with which this specification is concerned.

Whilst the invention is described with reference to water as the liquid, it will be understood that the term “liquid” is not so limited and other liquids may be useable with the invention.

### Shortage of Fresh Water

Some seventy percent (70%) of the earth's surface is covered by water of which ninety seven percent (97%) is salt water, leaving only three percent (3%) that is actually fresh water.

However, as some two percent (2%) of the fresh water is either locked up in the form of ice, is inaccessible or is unusable due to pollution, it leaves only one percent (1%) of the worlds fresh water available for use by both humans and all other creatures.

Of the one percent (1%) of fresh water available on earth, the Amazon river constitutes one third of this one percent (1%) and provides water for nine different countries in the region. The Amazon river is now so badly polluted by industry that many native inhabitants, whose lives and livelihood once revolved around the Amazon, have had to relocate to other areas.

According to the World Health Organisation:
A. At least one billion people now have no safe fresh water for drinking or sanitation.
B. The world is facing an increasingly critical shortage of clean water, in particular the African and Asian countries.
C. Twenty million people in six countries in west and central Africa rely on Lake Chad for water but the lake has shrunk by 95% in the last 38 years.
D. Two thirds of China's cities are facing severe water shortages.
E. In Iran, up to 60% of people living in rural areas could be forced to migrate to the cities due to water shortages.
F. The level of the “Aral Sea” in central Asia, formerly the worlds fourth largest inland sea, has dropped 16 meters and its area has almost halved.
G. Most cities of the former Soviet Union have water pollution problems and drinking water has to be boiled which does not, on its own, remove all pollutants.

Despite the many available means of treating polluted water using either filtration or distillation, in their present forms they are too costly especially for impoverished countries to use, particularly on a large scale.

The world has now reached a crucial stage where the lack of fresh water is, arguably, the most important problem faced by mankind. Without fresh water, many third world countries will not survive. It is therefore imperative that an inexpensive and effective means of providing fresh water be made readily available for use by all needy communities so that they have access to a means of purifying polluted and/or salt water to provide the fresh water so essential to the survival of mankind.

### Conventional Distillation Processes

The current method of distillation to purify water for drinking, or other purposes, is to heat the polluted liquid in an enclosed heatable boiler unit to raise the temperature of the liquid to, and be sustained at, boiling temperature. If the distilling device provides for the level of water in the boiler unit to be maintained at a pre-determined level for continuous production, the cooling factor of the replacement water must also be provided for to maintain the water at boiling point. The steam so produced is then passed through a condensing unit to convert the steam back to a liquid that is now largely free from contamination. Some commercial processes use multiple stages with reduced internal pressure at each stage to lower the boiling point and to reduce power consumption.

For current household distillation models and the like, the liquid residue from the polluted water that remains in the heatable boiler unit after use, for example minerals, inorganics, organics, salts, dead organisms and the like, need to be regularly removed and the unit thoroughly cleaned and disinfected. If the residue is not removed, a concentration of the polluting material will occur that can reduce the effectiveness of the distiller by further contaminating the incoming water as it is introduced into the boiler unit for distillation.

In addition, the heating elements of current conventional household distillers are subject to scaling and corrosion by the chemical pollutants present in the water being treated, particularly salts, and the heating elements will have to be replaced, at considerable cost, or a new distiller purchased.

Further, should there be even a low level of moisture left inside the boiler unit after use, and the distiller is not used again for just several days, bacteria can cultivate in that moisture.

When used for desalination, large scale distilling complexes are subject to considerable production downtime to allow for de-scaling, preparation and repair of corroded parts, possible replacement of heating units and cleaning of the system.

While the current conventional methods of distillation are effective, they are still more time consuming and costly to operate.

### DESCRIPTION OF THE INVENTION

This invention provides for a liquid treatment device with a heatable boiler component, of any suitable shape or size, with an appropriate lid element, or the like, coupled together with a suitable condensing component.

Unlike conventional distillation units, this invention does not require the liquid (eg water) to be brought to the boil to convert it to steam. This novel distillation device provides for the liquid that is to be treated (eg. purified), to be simply vaporized in the boiler component. This vaporisation inhibits particles of contaminated atomised fluid, from developing and passing into the distillation stage and affecting the purity of the distilled water.

According to first aspect of the invention a distillation device for treating liquid to be purified is provided comprising:
a) a boiler having an upper chamber and a lower chamber;
b) a liquid delivery system for delivering the liquid to the lower chamber;
c) a heater to heat the lower chamber to a predetermined temperature at which the liquid will be vaporized upon entering and/or contacting a surface of the lower chamber;
d) a vapor collector located in the upper chamber to receive and collect the vapor emanating from the lower chamber; and
e) a condenser in communication with the vapor collector to receive and condense that vapor into purified liquid.

According to second aspect of the invention a method is provided of treating liquid to be purified in a boiler having an upper chamber and a lower chamber comprising the steps of:
a) heating the lower chamber of the boiler to a predetermined temperature at which the liquid will be vaporized upon entering and/or contacting a surface of the lower chamber;
b) delivering the liquid to the lower chamber;
c) collecting in the upper chamber the vapor produced from the lower chamber; and
d) condensing the collected vapor into purified liquid.

Typically, the invention may be realised by injecting the water to be purified under pressure, through one or more atomising jets, into the boiler component as a mist or fog-like aerosol spray.

The polluted, or saline water, to be treated is introduced into the boiler by a suitable piping system that is provided at the outlet with one or more atomising jets. The water is subject to sufficient pressure (eg 50 pounds per square inch, or other pressure required by the atomising jet) that when passed through the outlet jet into the boiler it will be instantly vapourised within the boiler unit and/or upon contacting a surface of the lower chamber of the boiler unit. The exact size of the jet nozzle will vary depending upon the operating temperature and pressure to achieve subsequent vaporization by the boiler and this is well known to a person skilled in the art.

Examples of suitable nozzles (including fixed and rotating nozzles) for certain applications of the invention can be found at Spraying Systems Co of Wheaton, Ill. —US Catalogue—FogJet. In particular, rotating nozzles are preferred. The helicopter effect formed by the rotating nozzles increases the speed of the vapour flow in the boiler which in turn increases the volume of liquid which may be treated in the boiler. Typically, the nozzles are directed substantially horizontally so they are aimed at the wall of the boiler. It will be clearly understood that the opposing force of the nozzles cause the nozzle assembly to rotate. The design of the nozzle assembly (eg incorporation of rotors) may also induce an upward draft within the boiler.

Alternatively, vapourisation may be effected by the water to be purified being introduced into the boiler component as a droplet, or droplets, or the like, of such a dimension that the droplet/s will turn to steam on contact with the hot inner surface, or the heated atmosphere of the boiler unit. If required for a particular application of the invention, it may be a requirement to reduce the internal pressure in the distiller resulting in a flash steam process. Typically the size of the droplet will be less that 350 micron at 3 bar (Spraying Systems Co—Engineering Discussions: Key Performance Considerations—page 22 US Catalogue).

According to a preferred form of the invention, the vaporisation process is obtained by raising the temperature of the incoming water to less than 100° C. (ie not such that it boils within the inlet pipe), prior to it passing to the lower chamber of the boiler unit. Preferably, the water is preheated to a temperature between about 80° C. and about 100° C., more preferably about 90° C. and about 100° C., and most preferably about 95° C. and about 100° C. This may be achieved by exposing sufficient of the liquid delivery system leading to the lower chamber to the steam present within the boiler or a suitable separate heating source.

For household type devices, a suitable means is provided to heat the boiler component, such as an electric or gas heating element or any available suitable heat source such as wood or solar heat.

The invention is not limited to bench top household water purifying devices. The technology can be readily adapted for use on any scale, such as municipal, industrial, commercial, and particularly for the desalination of salt or brackish water.

For a large scale distillation or desalination complex, to minimise production costs, the heat for the boiler component may be provided by any type of heat released as a waste product from other industrial processes capable of heating the boiler component to a temperature in excess of 100° C.

Typically, the lid for the boiler component contains steam produced by the boiler component. An outlet is provided for steam to pass through into a condensing element, where it is progressively cooled until it again turns into the liquid state but without the presence of pollutants. These remain in the boiler component in a substantially dry state for easy removal either manually or by mechanical means.

Preferably, the heater for the boiler component is designed so that it has the capacity to heat the inner surfaces, together with the atmosphere within the boiler component, and maintain them at a temperature generally ranging from 100 to 200° C.

Further, it is known that some sources of the water to be purified may contain living organisms which can remain alive in temperatures in the order of 175° C. Where these are found to be present (eg brackish water), the invention preferably provides for a thermostatically controlled environment inside the boiler component that can be raised to a sufficient temperature that will kill those organisms. If the inner surfaces of the boiler component are sustained at a temperature in the order of 125° C., or higher (eg 200° C.) if subsequently found to be necessary, any mist of water inside the boiler component coming in contact with the hot inner surfaces of said boiler will have a barbeque effect on any living organisms not killed just by the internal ambient temperature within the boiler component. The term “barbeque effect” means that any organisms which are still present are substantially or entirely killed.

When the aerosol or mist like molecules of water come into contact with the hot inner surfaces of the boiler component, or the hot atmosphere therein, they will be instantly vapourised. This vapourisation inhibits particles of contaminated atomised fluid, from developing and passing into the distillation stage and affecting the purity of the distilled water.

Preferably, the atomizing jet(s) component located within the boiler component, may be provided with an adjustable micro spray jet, and/or a pressure control unit. The purpose is to ensure that the size of the aerosol molecules can be controlled either by the pressure applied to, or by the size or shape of, the atomising jet. This is to ensure that the molecules of water are of such a dimension that they will immediately atomise on contact with the hot inner surface of the boiler unit, or by the level of the atmospheric temperature within said boiler component. It will be understood that a reduction of pressure within the boiler component will assist in the vaporisation process.

Spraying of the liquid to be distilled, as an aerosol mist into the boiler component, may be either continuous or be subject to a periodic interruption, or pulse, of the atomising jet(s) spray into the body of the boiler component. This is to ensure that the temperature, within the boiler component is not caused to drop below the required level by an excess of water molecules sprayed into the boiler component.

To ensure that the temperature of the inner surfaces of the lower chamber of the boiler component are maintained at the required level, the jet(s) used to create the aerosol mist in the boiler component may be rotated to provide intermittent contact with the heated surfaces of the boiler unit.

In a further preferred form of the invention, the water flowing to the atomizing jet(s), inside the boiler component, may be preheated by directing the incoming water through a series of hollow spiral coils, or the like, suitably located inside the top of the boiler component so that the steam being created in the boiler component will substantially raise the heat of the water flowing through the coils, prior to it being injected into the boiler component, thus requiring less energy to raise the incoming water to boiling point. In another preferred form of the invention, the upper chamber comprises an outer wall and an inner wall defining a passageway. That passageway may be used as part of the liquid delivery system for the liquid. In this way, the inner wall operates as a heat exchanger to heat the water to be treated and simultaneously cool steam contacting the inner wall from the lower chamber.

Preferably, the ambient temperature within the lower chamber, may be controlled by a positive temperature coefficient device, or thermostat or the like, to maintain an internal temperature within the lower chamber that is substantially in excess of 100° C.

Typically, the pressure required to vaporise the water to be purified may be provided by municipal mains pressure or any suitable mechanical pressure pump, or other process, that may be either manually or power operated, or by gravity.

As the steam rises inside the boiler component, it will come in contact with the lid element that can be provided with any suitable means of cooling, depending on the output capacity of the distiller. For example, cooling means may be, by conventional refrigeration, a peltier effect cooling device, fan or by cold water circulation or the like. When so fitted, the said lid element may be maintained at a temperature somewhat less than 100° C., thus causing steam contacting said surface to condense.

It is anticipated that for smaller capacity models, when condensed steam forms on the inner surface of the lid of the boiler component and drains downwardly inside the lid, it can be collected in a gutter provided for the purpose. The gutter may be located within the lid element and water so collected is carried, by the gutter, to an outlet provided in the lid element to convey the water, together with the remaining steam from the boiler unit, to a condenser element.

Preferably, for a smaller boiler unit, the condensed steam may be ducted to and pass through a condensing element that can either form part of the lid unit or be a separate element of the boiler unit.

Preferably, a temperature sensitive device, such as a thermostat, may be provided to adjust and maintain the required temperature within the boiler unit.

To reduce heat conduction between the boiler unit and the lid element, a heat resistant insulating gasket, or the like, may be fitted at the junction of the lid element and the boiler unit.

It will be understood that the actual design of the boiler unit may vary in accordance with the available heat source to heat the boiler such as electricity, solar powered, gas, wood fire or the like. For example, when designed for use with electrical power the electrical element may be molded into the body of a ceramic pot or the like. Alternatively, it may be wrapped around, and fixed to, the outer surface of the boiler, and or coiled under the bottom of the boiler pot.

For small capacity distillation models, should the heat source be gas, firewood or the like, to improve heat conduction to the boiler pot the outside of the boiler pot may be provided with special heat conducting fins, or the like.

It will be understood that, the boiler unit may be manufactured from different materials to allow for different heat sources. For example, if using electrical, gas, or solar power, stainless steel, Pyrex, or the like may be used. For other forms of heat, the boiler may be manufactured from copper, ceramics, aluminium or the like, with the inner surfaces coated with a material, such as Teflon (p.t.f.e.) for ease of cleaning or health reasons related to the use of some of these materials.

Water from different sources may vary in the type of pollution it contains. If any “volatile organic compound” (voc) gasses are found to be present, after distillation, the gasses can be either vented to atmosphere, via an exhaust port that is usually located at a high point in the boiler lid element, or at the commencement of the condensing process. Alternatively, any such gasses present can be removed by post carbon filtration. Larger distillers may be fitted with extractor fans if necessary.

It will be understood that when polluted water is distilled there will be an accumulation of residue resulting from the dead bacteria and other organisms, chemical contaminants, heavy minerals, inorganic, organic material, or the like, found in the water that caused the pollution. Periodically the residue must be removed. Removing the residue is conventionally a difficult and time consuming task; even if chemicals are used to clean the tank of the boiler pot they may also themselves leave behind a chemical pollutant.

Accordingly, the boiler unit of the invention may preferably be constructed for easy access. For example, for household models, a removable lid element is provided to allow easy access to the smooth inner surfaces of the open topped boiler pot for cleaning purposes.

Characteristic of the invention is that the boiler component surfaces and residue remain substantially clean and dry and dry out completely when the device is turned off due to latent heat, thus preventing the growth of any bacteria within the device. This “100% Water Retention” feature of the invention simply means that no wet waste (eg brine) is produced—and the associated cost of waste disposal is reduced. This has the additional advantage that this residue may be readily removed by either tipping it out, vacuuming, wiping or washing away any residue. By selection of suitable boiler surface material/shape, the dry material will fall and accumulate in a lower part of the boiler under the influence of gravity and therefore be essentially automatically self cleaning. This means that there is little need to shut down the boiler for cleaning. This is in contrast to the prior art where wet residue is formed and periodic shut down is required to remove this residue.

Preferably, the boiler component may be designed with an outlet or trap at its base to provide ready removal of the residue and for easy cleaning.

It is anticipated that for some forms of the household sized models of the invention, to facilitate removal of any residue, a special disposable inner lining may be provided that will both contact and cover the base and sides of the boiler pot. It will also be understood that the design of such a lining would provide for substantial contact with both the bottom and sides of the boiler unit such that there will be effective heat transfer to the lining to ensure that the boiler unit sustains the temperature required to produce steam.

Further, the lining may preferably be made of a suitable, high quality conducting material, such as aluminium foil, or the like. It will be understood that the lining for the boiler unit may not necessarily be made or molded in sheet form but may be made of a suitable fine mesh gauze. With the lid element removed, any residue in the boiler unit can then be readily removed by lifting out the lining and replaced with a fresh lining.

For industrial or commercial sized distillation or desalination plants, the bottom of the boiler unit may be shaped to act as a funnel. A suitably sized drain, provided with a suitable mechanism to control the drain outlet, may be provided in the centre of the funnel through which, the disposal of dry, or semi-dry if preferred, residue matter, or sodium chloride when the device is used for desalination, can be continuously drained by gravity, into a storage hopper located beneath the drain hole. It will be understood that in accordance with the technology employed by the invention the sodium chloride residue, after desalination, is substantially dry and being subject to the force of gravity can drain to the outlet of the boiler funnel.

It is anticipated that for large scale distillation and desalination plants, electricity is the preferred power source but this does not exclude the adaptation of this invention to use alternative means of heating. To provide heat within the boiler, the heater elements may be coiled both beneath the funnel shaped base and coiled up and around the outside of the boiler unit. Likewise, the heating elements may be molded within the walls to form an integral part of the boiler tank.

Preferably, where the heater coils are located beneath the base of the boiler unit funnel, those coils may also provide heat within the hopper unit to maintain the required operating temperature in the hopper as it is in the boiler unit. However, it may be necessary to provide additional heating for the hopper.

Alternatively, an outlet drain hole in the bottom of the boiler unit is provided with a closeable door that may be normally fully open allowing salt produced in the boiler to slide into and collect in the hopper situated below the boiler. Alternatively, if it is necessary to maintain the internal temperature of the boiler, the door may be kept closed and the salt produced held within the boiler and the salt drained from the boiler to the hopper as required. The boiler outlet door may be either of the sliding or hinged type, or the like. Preferably, the hopper also has a funnel shaped bottom or the like and associated outlet drain hole and closeable door. When the boiler door is closed, the salt can be drained from the hopper, either onto a conveyor belt or onto a truck or train, or the like. If required for commercial reasons, the salt (sodium chloride) may be kept in a moist state by adjustment of either or both the heat and the amount of water mist injected into the boiler unit. The purpose of this is to provide a salt that is suitable for either slow drying or for further processing to remove minerals to suit a commercial requirement. Minerals contained in sea salt are highly valued.

By utilizing the invention for the desalination of sea water, there is no brine residue to be continually disposed of, at considerable cost, as is the case with the two major technologies currently used for desalination, i.e. multi stage flash distillation and reverse osmosis. The residue is substantially dry, sodium chloride (salt), which is in itself a marketable commodity.

If the invention is to be applied to continuous production, it will provide for a means to continuously remove the salt or other residue from the boiler unit with no loss of production.

Also, the requirement to totally shut down the plant for technical difficulties and maintenance is a particular problem with current desalination treatment systems. With existing desalination or brackish water treatment plants cleaning of the plant components and repainting them is an expensive and time consuming process. It will be understood that by utilizing the invention there may be no requirement to cease production, as when it is used for a large installation, the plant will consist of a suitable number of identical modules connected to a manifold leading to the condensing stage.

Should the need arise, the cleaning, or flushing with water, of the inner surfaces of one form of the boiler unit as described above can typically be accomplished by adopting the following procedure:—
1. Lower the temperature of the boiler so that the water mist will not turn into steam.
2. Continue to spray the water mist that will then turn to globules of water and flow down the sides of the boiler and out through the funnel so washing any residue from the boiler into a suitable container.
3. As the hopper also has a funnel shaped bottom, the small quantity of brine, from the boiler flushing operation, can be captured in a suitable vessel, and if necessary recycled through the system.
4. Should it be necessary to prevent the production of brine when flushing the boiler tank, fresh water can be used by the provision of a diverter valve prior to the treatment water inlet to temporarily direct fresh water through the misting jet.

As distinct from current water purifying technology, this invention may also provide a plant based on a modular design that enables the manufacture of a predetermined capacity base production module. The production capacity of the plant may be increased by the addition of more modules, when necessary.

Where it is currently the practice to construct a water treatment or desalination plant to cater for not only the estimated demand but also future expansion, there is higher than necessary initial capital outlay. Alternatively, to reduce the initial capital costs of construction and installation of a new plant, it is only necessary to install the currently required number of modules of plants according to the invention and later add additional modules when capacity needs to be increased.

In addition, rather than building on site one very large plant with a non variable capacity, it is an advantage to use modules of fixed capacity output that allows them to be manufactured in volume at less cost away from the installation site. To further reduce capital costs, the modules can be made in kit form in any suitable location. The modular design also enables them to be made transportable, by land or sea, to the required destination.

Also, the use of a modular design incorporating the invention can provide an additional production cost saving as there is no loss of production for repairs, maintenance or breakdowns, as is the present case. By the use of a modular plant as in this invention, it permits individual modules to be off line at any one time as the water inlet, and steam output of each module is interconnected by a manifold, or the like, and can be individually isolated when necessary.

When used for water purifying, desalination or similar processes, the modular design provides for each of the boiler units to be connected via a manifold, or the like, that will conduct the steam produced by each individual boiler module to one or more condenser units that can then be connected to a “treated water” supply line for bulk storage.

Furthermore, the modules forming the desalination unit may be manufactured of any suitable corrosion resistant material such as stainless steel, ceramics or a metal coated with Teflon, or the like.

It will be further understood that this innovative process of injecting a mist, or droplet, of water into an appropriately heated environment has other applications. For example, if used in conjunction with domestic hot water systems and the water is injected as a mist into a tank, as and when required, it could provide considerable cost savings in energy also the heater tank can be substantially reduced in size with the advantages of reduced weight and unit cost.

It is generally accepted that when boiling water the production of steam is limited to the diameter of the top surface of the water. In accordance with the invention, for example, a tank 100 mm in diameter with sides 200 mm high has a surface area with the potential to create steam many times greater than by just boiling the water in the same tank. This equates to a higher level of efficiency and requires less energy.

Accordingly, in a further form of the invention, a liquid heating device is provided comprising:
a) a boiler having an upper chamber and a lower chamber;
b) a water delivery system for delivering the liquid to the lower chamber;
c) a heater to heat the lower chamber to a predetermined temperature at which the liquid will be vaporized upon entering and/or contacting a surface of the lower chamber;
d) a vapor collector located in the upper chamber to receive and collect the vapor emanating from the lower chamber; and
e) a condenser in communication with the vapor collector to receive and condense that vapor into liquid having a predetermined temperature.

Accordingly, in a further form of the invention, a method of heating liquid in a boiler having an upper chamber and a lower chamber comprising the steps of:
a) heating the lower chamber of the boiler to a predetermined temperature at which the liquid will be vaporized upon entering and/or contacting a surface of the lower chamber;
b) delivering the liquid to the lower chamber;
c) collecting in the upper chamber the vapor produced from the lower chamber; and
d) condensing the collected vapor into liquid of a predetermined temperature.

### Summary of Benefits of the Invention

One or more of the follow benefits are achievable by utilizing the invention in its various forms. These include:
a. use to remove pollutants from water based liquids to a quality suitable for medical, chemical or industrial uses, or for consumption by living creatures and plant life or for any other purpose.
b. the process of injecting polluted liquid into a heated boiler pot, in the form of an aerosol mist, is both quicker, and less costly, than using the conventional method of first bringing the liquid to the boiling point and then maintaining it at that temperature to affect the distillation process.
c. when the aerosol of the liquid to be processed contacts the heated surface of the heater unit, or the hot internal atmosphere, it is immediately converted into steam, thus saving the cost and time of heating a substantial body of water and maintaining it at boiling point.
d. the amount of steam released when just boiling water is limited to the area of the exposed upper surface of the boiling water.
e. provides for the use of both the sides and the base of the boiler together with the ambient internal temperature to create steam.
f. if the water to be treated is sprayed continuously, as an aerosol mist and not liquid drops of water, the residue is kept in substantially dry form with reduced possibility of pollutants flowing with the purified liquid.
g. with the smaller household distillers the boiler units, with the lid removed, exposes the interior that is readily accessible for the removal of dry/substantially dry polluting residue.
h. lower energy requirements.
i. readily adaptable by modification of design for heating by alternative heat sources such as solar energy, gas or wood fires or the like.
j. can be used for any process that requires, or benefits from, spray distillation.
k. when used for desalinating sea water, this process also provides a beneficial by-product of dry/substantially dry sea salt that is also a commercially viable commodity that is produced continuously. Conventional salt production by solar evaporation takes months.
l. currently, the brine that remains as a result of current methods of desalination, must be disposed of in a means approved by regulatory authorities. The overhead cost of brine disposal is considerable as in many desalination plants it has to be pumped through pipes that have to be laid to an outlet well out to sea. If the desalination plant is inland the problem of brine disposal is even more difficult and costly. Also, the toxic brine outlet must be relocated regularly as the toxins affect the living organisms in the area.
m. when used for desalination, no brine residue remains to be disposed of.
n. not destructive to components of the distiller such as scaling of the heater element and other components
o. no need to have a pressurised sealed unit which could otherwise present safety concerns.
p. can remove pollutants and also kill undesirable organisms unlike the conventional Reverse Osmosis and Multi Stage Flash Distillation.
q. can be adapted for use with other water based appliances, such as the heater tank of a hot water service or the like.
r. the salt residue from desalination can be automatically drained from the boiler as it is created.
s. this desalination boiler can be designed to be automated to self-clean.
t. production costs are less than conventional costs for large scale water treatment, one basic module of the invention can be adapted for use in all water treatment applications of the invention, and further modules added as required.

### DESCRIPTION OF THE DRAWINGS

The invention is now further illustrated with reference to the drawings in which:

FIG. 1 is a perspective view of a distilling device according to the invention.

FIG. 2 is a vertical cross section through the boiling component 1A of the distilling device illustrated in FIG. 1.

FIG. 3 is a vertical cross section through the lid element of the boiling pot 1A of the distilling device illustrated in FIG. 1

FIG. 4 is a vertical cross section through the cooling condenser 1C of the distilling device illustrated in FIG. 1.

FIG. 5 refers to a vertical cross section through lid 5 in FIG. 1C.

FIG. 6 is a vertical cross section of a heat exchanger/preheater for use with the distilling device.

FIG. 7 is a horizontal cross section of the heat exchanger/preheater of FIG. 6.

FIG. 8 is a perspective view of a spiral inlet tube for use in the distilling device.

FIG. 9 is a cross sectional view through the an alternate form of the distilling device of the invention with the spiral inlet tube of FIG. 8 in place.

FIG. 10 is a 3-dimensional view of a nozzle for use in the invention.

Referring to FIG. 1, the distilling device is depicted as comprising two main components being a boiler pot 1A having a lid element 1B and a cooling condenser 1C. A pressurised water inlet pipe 1 is fixed to a lid element 1B to supply water to be distilled to it. A second pipe 4 carries condensed steam from lid element 1B to the cooling condenser 1C. A pair of clamps 3 are provided on opposite sides of the lid element 1B and boiler pot 1A to fasten these components together.

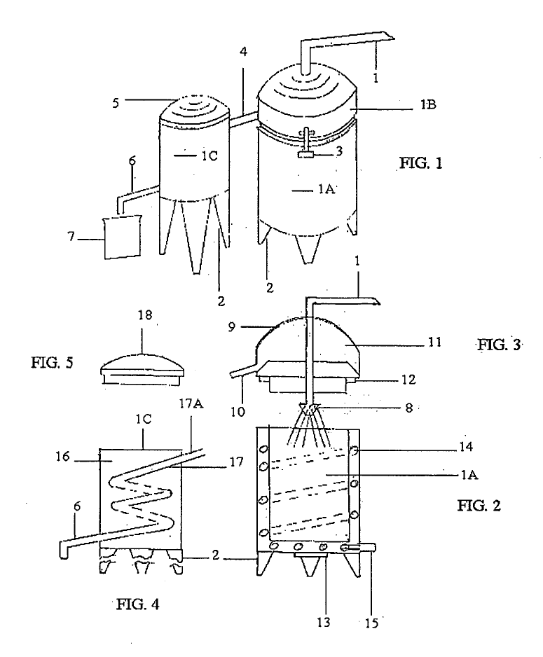

As more particularly shown in FIGS. 2 and 3, pipe 1 extends downwardly inside the lid element 1B and extends from lid element 1B into boiler pot 1A. Whilst the relativity shown in FIGS. 2 and 3 has the pipe 1 ending above boiler pot 1A, it will be understood that when lid element 1B is positioned on boiler pot 1A, pipe 1 will be in the center of and near the top of boiler pot 1A. An aerosol spray head 8 is attached to pipe 1 and is designed to spray the water to be purified, throughout the boiler pot 1A.

Boiler pot 1A is also provided with an electrical power inlet 15 which is connected to an electrical heating element 14 integrated (eg by molding) into the cylindrical wall of boiler pot 1A. Boiler pot 1A is heated by electrical element 14. Typically, boiler pot 1A is manufactured of a suitable, heatable, material such as ceramic or the like and with an insulating external skin. Thermostat 13 is provided to control the heat of the boiler pot 1A. The boiler pot 1A is also provided with legs 2.

Lid element 1B comprises lid 9 which receives and contains the steam created in the boiler pot 1A. The exterior of lid 9 may be used to assist in condensing the steam created in the boiler pot 1A by the provision of an external fan, not shown, to blow cold air over the outer surface of lid 9 to keep the surface temperature of lid 9 at less than 100° C.

Lid element 1B also comprises a gutter 11 formed by the connection of an open topped frustoconical cone element to the inside peripheral lower surface of the lid 9. That gutter 11 permits collection of condensed steam forming on the inner surface of lid 9. The condensed steam gravitates into the gutter 11 and passes out of steam outlet 10 into pipe 4 to the condensing element 1C.

As also shown in FIG. 3, an insulating gasket 12 is interposed between boiler pot 1A and lid 9 to reduce the conduction of heat between 1A and 9.

Cooling condenser 1C is shown in more detail in FIGS. 4 and 5. Cooling condenser 1C has an outer case 16 and may, if needed, contain cooling fluid to assist the heat transfer cooling process. The condenser 1C is fitted with a lid 5 having an exterior surface 18 to seal it to the condenser 1C.

To further condense the condensed steam and/or water produced in boiler pot 1A and passed to the condenser 1C, a cooling coil 17 is mounted in cooling condenser 1C. The steam, when condensed to a liquid in cooling coil 17, is carried to outlet pipe 6 then to container 7. Inlet pipe 17a receives steam and/or water from outlet pipe 10 via pipe 4.

In operation, water to be purified is passed through inlet pipe 1 and is sprayed into boiler pot 1A via aerosol spray head 8. The fine mist is heated to form steam which rises through boiler pot 1A into the lid 9 of lid element 1B. Upon contacting lid 9 the steam condenses and gravitates into gutter 11. The condensed steam and/or water then passes via pipe 4 into a cooling coil 17 to be further condensed by heat exchange. Purified water then passes from cooling coil 17 via outlet 6 into a container 7.

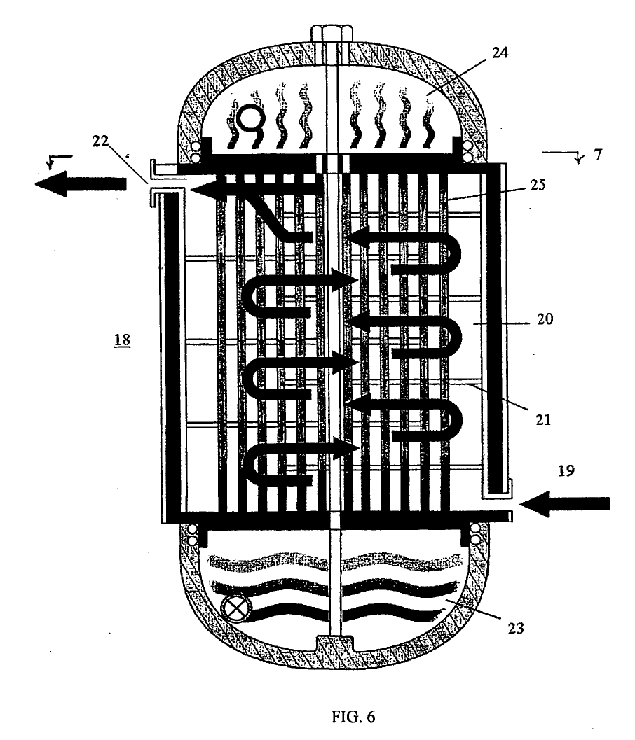

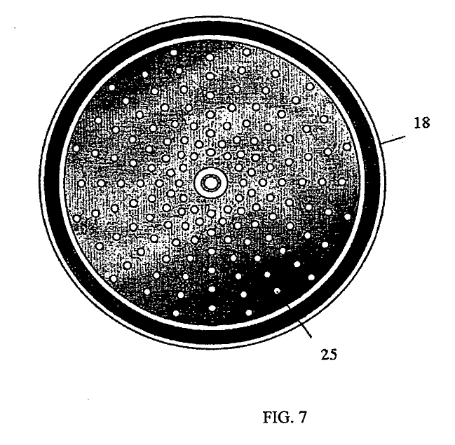

In FIGS. 6 and 7 a preheater/heat exchanger 18 is shown which is used to heat the liquid which is destined to be introduced and purified in the distiller depicted in FIGS. 1 to 5, It also cools the purified material flowing from that distiller. As such it will replace cooling condenser 1C.

The heat exchanger 18 comprises an inlet 19 through which that liquid (usually cold or at room temperature) passes into a heat exchanger chamber 20. In chamber 20 is a series of radial baffles 21 which with chamber 20 define a flow path (see the arrows) which the liquid must pass before it exits chamber 20 through outlet 22.

Heat exchanger 18 also comprises fluid chambers 23 and 24 abutting either end of chamber 20 and a series of tubes 25 communicating with chambers 23 and 24 which pass through chamber 20. Purified material (including vapour material) having an elevated temperature and emanating from the distiller passes into chamber 23 and then flows via tubes 25 to chamber 24. In so doing those materials are in heat exchange relationship with the liquid circulating in chamber 20.

Therefore this heat exchanger 18 has two functions:
1. The pressurised contaminated cold liquid to be treated helps cool the purified steam vapour inside the multiple tubes. This quickens the process of turning the vapour into purified liquid.
2. Secondly, when the cold contaminated liquid comes into contact with the multiple hot tubes, the contaminated liquid is heated and thus less energy is required to run the process of purification.

Further, the liquid when treated in the distiller is heated to a much higher temperature then traditional methods of liquid purification. Therefore preheating reduces the energy necessary to achieve that higher temperature. At an incoming temperature of 101° C. droplets of liquid (eg water) are converted in the distiller into steam vapour within 25 milliseconds. Typically, the stabilized temperature in the boiler pot 1A reaches between 150 to 200° C. which increases the output of vapour by 50 to 75%.

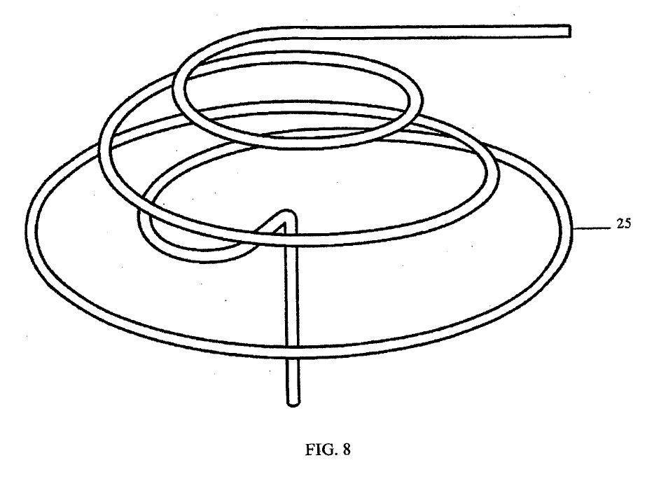

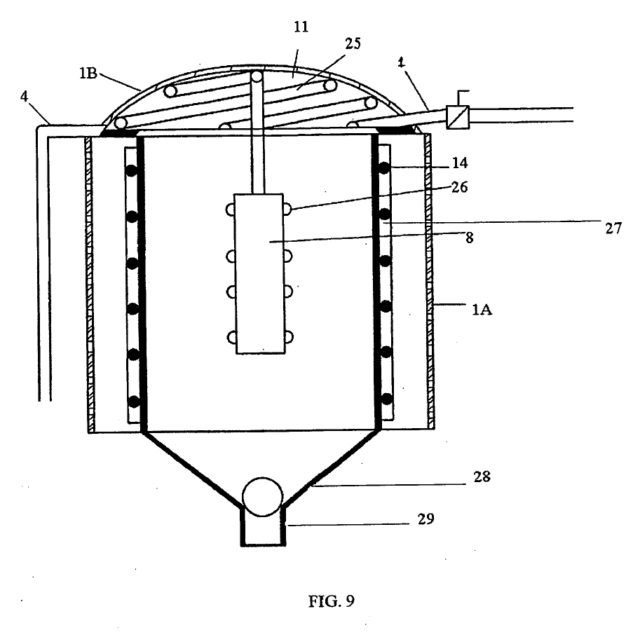

Another characteristic of the invention is illustrated in FIGS. 8 and 9 in which the pressurised liquid flows from exchanger 18 (FIG. 6) into the spiral tube 25 of the distiller.

More specifically, the spiral tube 25 is located in lid element 1B. This spiral tube connects to a rotating spray head 8 with mist nozzles 26. By using this method the incoming liquid is heated by heat exchange with vapour which is entering lid element 1B. Simultaneously, that heat exchange assists cooling and condensation of the purified vapour. This further reduces the energy required for the purification process.

As the atomized liquid is instantaneously vaporised in contact with the walls 27, impurities are immediately separated from the vapor and are substantially or totally dry. Under the influence of gravity these impurities fall towards frustoconical section 28 which directs the impurities towards outlet 29. That impurity outlet 29 may be closed or open to allow the impurities to be selectively removed from pot 1A without the need to shut down the distiller.

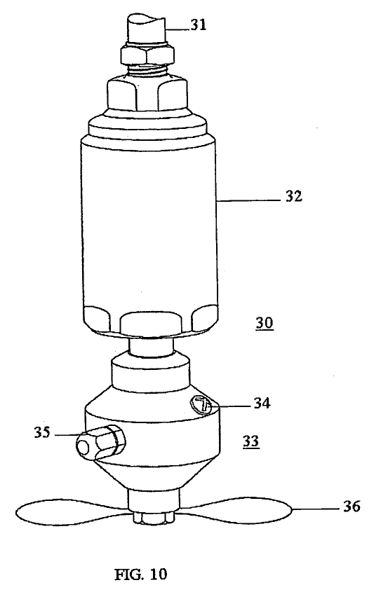

In FIG. 10 a nozzle assembly 30 is shown for use in the invention. More specifically, the liquid enters into the nozzle assembly 30 through top inlet 31. It then passes through body 32 into a rotating nozzle support 33. Support 33 is provided with a number of nozzle sites 34 into which horizontally oppositely directed spray nozzle(s) 35 are inserted opposing force of the nozzles 35 spraying the mist rotates he aerosol head on a horizontal plane. The nozzle assembly support 33 also has rotor blades 36 which provide an upward draft. This additional upward draft in the distiller device allows for a higher rate of water vapour to pass through the main chamber.

The exact size of the jet nozzle will vary depending upon the operating temperature and pressure to achieve subsequent vaporization by the boiler and this is well known to a person skilled in the art.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

The word ‘comprising’ and forms of the word ‘comprising’ as used in this description and in the claims does not limit the invention claimed to exclude any variants or additions.

1. A distillation device for treating liquid to be purified comprising:
a) a boiler having an upper chamber and a lower chamber;
b) a liquid delivery system for delivering the liquid to the lower chamber;
c) a heater to heat the lower chamber to a predetermined temperature at which the liquid will be vaporized upon entering and/or contacting a surface of the lower chamber;
d) a vapor collector located in the upper chamber to receive and collect the vapor emanating from the lower chamber; and
e) a condenser in communication with the vapor collector to receive and condense that vapor into purified liquid.

2. The distillation device according to claim 1 further comprising a residue collector located in or below the lower chamber to collect substantially dry residue formed in the lower chamber.

3. The distillation device according to claim 1 wherein the liquid delivery system includes at least one atomising jet through which the liquid passes to produce a mist or fog-like aerosol spray.

4. The distillation device according to claim 2 wherein the at least one atomising jet is located in an upper part of the lower chamber.

5. The distillation device according to claim 2 wherein the atomizing jet is an adjustable micro spray jet and/or a pressure control unit.

6. The distillation device according to claim 2 wherein the atomizing jet is rotatable.

7. The distillation device according to claim 6 wherein two or more atomizing jets are rotatable.

8. The distillation device according to claim 1 wherein the liquid delivery system includes a liquid conditioner to cause the liquid to be introduced into the lower chamber in the form of droplets.

9. The distillation device according to claim 8 wherein the droplets have dimensions of less than 350 micron at 3 bar.

10. The distillation device according to claim 1 wherein a part of the water delivery system is located in the upper chamber and in heat exchange relationship with the vapor to preheat the liquid in the liquid delivery system to a predetermined temperature.

11. The distillation device according to claim 10 wherein the part includes a spiral to extend the distance and/or time over which the heat exchange relationship exists.

12. The distillation device according to claim 1 further comprising a liquid pre-heater to preheat the liquid in the liquid delivery system to a predetermined temperature.

13. The distillation device according to claim 10 wherein the predetermined temperature of the liquid is in the range of up to about 100° C.

14. The distillation device according to claim 10 wherein the predetermined temperature of the liquid is in the range of between about 80° C. and about 100° C.

15. The distillation device according to claim 10 wherein the predetermined temperature of the liquid is in the range of between about 90° C. and about 100° C.

16. The distillation device according to claim 10 wherein the predetermined temperature of the liquid is in the range of between about 95° C. and about 100° C.

17. The distillation device according to claim 1 wherein the predetermined temperature of the heater is in the range of 100-125° C.

18. The distillation device according to claim 1 wherein the heater further comprises a thermostat to maintain the lower chamber at the predetermined temperature.

19. The distillation device according to claim 1 further comprising a cooler for the vapor collector wherein the cooler maintains the vapor collector below a predetermined temperature.

20. The distillation device according to claim 19 wherein the predetermined temperature is below 100° C.

21. The distillation device according to claim 1 wherein the lower chamber has an outlet for removal of residue collected in the lower chamber.

22. A method of treating liquid to be purified in a boiler having an upper chamber and a lower chamber comprising the steps of:
a) heating the lower chamber of the boiler to a predetermined temperature at which the liquid will be vaporized upon entering and/or contacting a surface of the lower chamber;
b) delivering the liquid to the lower chamber;
c) collecting in the upper chamber the vapor produced from the lower chamber; and
d) condensing the collected vapor into purified liquid.

23. The method according to claim 22 further comprising the step of collecting substantially dry residue in a residue collector located in or below the lower chamber.

24. The method according to claim 22 wherein the liquid is delivered to the lower chamber in atomized form.

25. The method according to claim 22 wherein the liquid is delivered to the lower chamber as a mist or fog-like aerosol spray.

26. The method according to claim 22 wherein the liquid is delivered to lower chamber in the form of droplets.

27. The method according to claim 26 wherein the droplets have dimensions of less than 350 micron at 3 bar.

28. The method according to claim 22 wherein the liquid is delivered to differing areas of the lower chamber over time.

29. The method according to claim 22 wherein the liquid to be delivered to the lower chamber is preheated to a predetermined temperature.

30. The method according to claim 29 wherein the liquid is preheated by heat exchange with the vapor being collected in the upper chamber.

31. The method according to claim 29 wherein the predetermined temperature of the liquid is in the range of up to about 100° C.

32. The method according to claim 29 wherein the predetermined temperature of the liquid is in the range of between about 80° C. and about 100° C.

33. The method according to claim 29 wherein the predetermined temperature of the liquid is in the range of between about 90° C. and about 100° C.

34. The method according to claim 29 wherein the predetermined temperature of the liquid is in the range of between about 95° C. and about 100° C.

35. The method according to claim 22 wherein the lower chamber is preheated to a temperature in the range of 100-125° C.

36. The method according to claim 22 further comprising the step of removing residue collected in the lower chamber.

37. A liquid heating device comprising:
a) a boiler having an upper chamber and a lower chamber;
b) a water delivery system for delivering the liquid to the lower chamber,
c) a heater to heat the lower chamber to a predetermined temperature at which the liquid will be vaporized upon entering and/or contacting a surface of the lower chamber;
d) a vapor collector located in the upper chamber to receive and collect the vapor emanating from the lower chamber; and
e) a condenser in communication with the vapor collector to receive and condense that vapor into liquid having a predetermined temperature.

38. The distillation device according to claim 37 further comprising a residue collector located in or below the lower chamber to collect substantially dry residue formed in the lower chamber.

39. The liquid heating device according to claim 37 wherein a part of the water delivery system is located in the upper chamber and in heat exchange relationship with the vapor to preheat the liquid in the liquid delivery system to a predetermined temperature.

40. The distillation device according to claim 39 wherein the part includes a spiral to extend the distance and/or time over which the heat exchange relationship exists.

41. The liquid heating device according to claim 37 further comprising a liquid pre-heater to preheat the liquid in the liquid delivery system to a predetermined temperature.

42. The liquid heating device according to claim 37 wherein the predetermined temperature of the liquid is in the range of up to about 100° C.

43. The liquid heating device according to claim 37 wherein the predetermined temperature of the liquid is in the range of between about 80° C. and about 100° C.

44. The liquid heating device according to claim 37 wherein the predetermined temperature of the liquid is in the range of between about 90° C. and about 100° C.

45. The liquid heating device according to claims 37 wherein the predetermined temperature of the liquid is in the range of between about 95° C. and about 100° C.

46. The liquid delivery system according to claim 37 wherein the water deliver system includes at least two rotatable atomizing jets through which the liquid passes to produce a mist or fog-like aerosol spray.

47. A method of heating liquid in a boiler having an upper chamber and a lower chamber comprising the steps of:
a) heating the lower chamber of the boiler to a predetermined temperature at which the liquid will be vaporized upon entering and/or contacting a surface of the lower chamber,
b) delivering the liquid to the lower chamber;
c) collecting in the upper chamber the vapor produced from the lower chamber; and
d) condensing the collected vapor into liquid of a predetermined temperature.

48. The method according to claim 47 further comprising the step of collecting substantially dry residue in a residue collector located in or below the lower chamber.

49. The method of heating liquid according to claim 47 further comprising a liquid pre-heater to preheat the liquid in the liquid delivery system to a predetermined temperature.

50. The method of heating liquid according to claim 47 wherein the predetermined temperature of the liquid is in the range of up to about 100° C.

51. The method of heating liquid according to claim 47 wherein the predetermined temperature of the liquid is in the range of between about 80° C. and about 100° C.

52. The method of heating liquid according to claim 47 wherein the predetermined temperature of the liquid is in the range of between about 90° C. and about 100° C.

53. The method of heating liquid according to claim 47 wherein the predetermined temperature of the liquid is in the range of between about 95° C. and about 100° C.

54. A distillation device for treating liquid containing organisms comprising:
a) a boiler having an upper chamber and a lower chamber;
b) a liquid delivery system for delivering the liquid to the lower chamber;
c) a heater to heat the lower chamber to a predetermined temperature at which the liquid will be vaporized the organisms substantially or entirely killed upon entering and/or contacting a surface of the lower chamber;
d) a vapor collector located in the upper chamber to receive and collect the vapor emanating from the lower chamber; and
e) a condenser in communication with the vapor collector to receive and condense that vapor into purified liquid.

55. A method of treating liquid containing organisms in a boiler having an upper chamber and a lower chamber comprising the steps of:
a) heating the lower chamber of the boiler to a predetermined temperature at which the liquid will be vaporized and the organisms substantially or entirely killed upon entering and/or contacting a surface of the lower chamber;
b) delivering the liquid to the lower chamber;
c) collecting in the upper chamber the vapor produced from the lower chamber; and
d) condensing the collected vapor into purified liquid.
